(19) United States
(12) Patent Application Publication
(10) Pub. No.: US 2025/0168601 A1
(43) Pub. Date: May 22, 2025

(54) COMMUNICATION SYSTEM

(71) Applicant: NEC Corporation, Minato-ku, Tokyo (JP)

(72) Inventor: Zhe CHEN, Guildford (GB)

(73) Assignee: NEC Corporation, Minato-ku, Tokyo (JP)

(21) Appl. No.: 18/841,718

(22) PCT Filed: Mar. 16, 2023
(86) PCT No.: PCT/JP2023/010479

§ 371 Date: Aug. 27, 2024

(30) Foreign Application Priority Data
Mar. 25, 2022 (GB) 2204294.9

(51) Int. Cl. H04W 4/06; H04W 36/00; H04W 48/20; H04W 76/27; H04W 76/34; H04W 76/40

(52) U.S. Cl. CPC H04W 4/06; H04W 36/0007; H04W 48/20; H04W 76/27; H04W 76/34; H04W 76/40

(57) ABSTRACT

A communication system is disclosed in which Multicast and Broadcast Services (MBS) may be provided via multicast, for user equipment (UE) in an inactive state. A distributed unit of a base station apparatus receives, from a central unit of the base station apparatus, information identifying at least one MBS session and information identifying that the at least one MBS session is to be provided in a cell via multicast for the UE in the inactive state.

### TECHNICAL FIELD

The present disclosure relates to a wireless communication system and devices.

### BACKGROUND ART

The present disclosure relates to a wireless communication system and devices thereof operating according to the 3rd Generation Partnership Project (3GPP) standards or equivalents or derivatives thereof. The disclosure has particular but not exclusive relevance to improvements relating to multimedia broadcast sessions in the so-called ‘5G’ (or ‘Next Generation’) systems.

The latest developments of the 3GPP standards are referred to as ‘5G’ or ‘New Radio’ (NR). These terms refer to an evolving communication technology that supports a variety of applications and services. Various details of 5G networks are described in, for example, the ‘NGMN 5G White Paper’ V1.0 by the Next Generation Mobile Networks (NGMN) Alliance, which document is available from https://www.ngmn.org/5g-white-paper.html. 3GPP intends to support 5G by way of the so-called 3GPP Next Generation (NextGen) radio access network (RAN) and the 3GPP NextGen core network (NGC).

Under the 3GPP standards, the base station (e.g. an ‘eNB’ in 4G or a ‘gNB’ in 5G) is a node via which communication devices (user equipment or ‘UE’) connect to a core network and communicate to other communication devices or remote servers. For simplicity, the present disclosure will use the term base station to refer to any such base stations.

In the 5G architecture, the gNB internal structure may be split into two parts known as the Central Unit (CU) and the Distributed Unit (DU). In this ‘split’ architecture, typically ‘higher’, CU layers (for example, but not necessarily or exclusively), PDCP) and the typically ‘lower’, DU layers (for example, but not necessarily or exclusively, RLC/MAC/PHY) may be implemented separately. Thus, for example, the higher layer CU functionality for a number of gNBs may be implemented centrally (for example, by a single processing unit, or in a cloud-based or virtualised system), whilst retaining the lower layer DU functionality locally, in each of the gNB.

For simplicity, the present disclosure will use the term mobile device, user device, or UE to refer to any communication device that is able to connect to the core network via one or more base stations, including distributed base stations and units thereof.

Communication devices might be, for example, mobile communication devices such as mobile telephones, smartphones, user equipment, personal digital assistants, laptop/tablet computers, web browsers, e-book readers and/or the like. Such mobile (or even generally stationary) devices are typically operated by a user. However, 3GPP standards also make it possible to connect so-called ‘Internet of Things’ (IoT) devices (e.g. Narrow-Band IoT (NB-IoT) devices) to the network, which typically comprise automated equipment, such as various measuring equipment, telemetry equipment, monitoring systems, tracking and tracing devices, in-vehicle safety systems, vehicle maintenance systems, road sensors, digital billboards, point of sale (POS) terminals, remote control systems, and the like. Effectively, the Internet of Things is a network of devices (or “things”) equipped with appropriate electronics, software, sensors, network connectivity, and/or the like, which enables these devices to collect and exchange data with each other and with other communication devices. It will be appreciated that IoT devices are sometimes also referred to as Machine-Type Communication (MTC) communication devices or Machine-to-Machine (M2M) communication devices.

For simplicity, the present disclosure often refers to mobile devices in the description but it will be appreciated that the technology described can be implemented on any communication devices (mobile and/or generally stationary) that can connect to a communications network for sending/receiving data, regardless of whether such communication devices are controlled by human input or software instructions stored in memory.

The so-called Radio Resource Control (RRC) protocol is a control plane protocol between the UE and the radio access network (base station). RRC has three distinct states (in 5G): RRC_IDLE; RRC_CONNECTED; and RRC_INACTIVE. The functions in each state, and state transitions are defined in the 3GPP TS 38.331 V16.7.0 standard (a Release 17 version has not been published yet). In summary, in the RRC connected state, radio resources are allocated to the UE and typically active (user plane or control plane) communication is taking place between the UE and the network. When radio resources are no longer needed, the network can decide to release the RRC connection causing the UE to enter the RRC idle state. In the RRC idle state no active communication is taking place between the UE and the network. The third, RRC inactive state was introduced in 5G to provide an ‘always on’ type of connection. Specifically, when the network decides to release the UE to the inactive state (instead of the idle state), the RRC connection can be resumed when needed without excessive signalling. This is achieved (amongst others) by maintaining the applicable radio and security configurations at the UE and the radio access network (base station). In the RRC connected state, UE mobility is controlled by the network through handovers between cells. In RRC idle and inactive state, the UE performs measurements of neighbouring cells and performs cell reselections when needed (based on the results of the measurements).

One of the recent features being developed over the existing 5G framework is referred to as Multicast and Broadcast Services (MBS). This functionality aims to enhance 5G New Radio and 5G Core Network capabilities for a reliable, low latency, resource efficient, and massive deployment of a wide array of multicast and broadcast services. 3GPP is currently specifying the details of MBS for media distribution over mobile broadband networks. MBS (or ‘NR MBS’ in 5G) aims to reuse cellular infrastructure such as the so-called Low Power Low Tower (LPLT) infrastructure. One of the main use cases is the delivery of linear/live media content to smartphones, tablets, vehicles, and other mobile (or stationary) devices. Although MBS is designed to use existing (or already specified) 3GPP infrastructure, MBS can provide a more efficient delivery of multicast/broadcast traffic than unicast communication using the same infrastructure. Details of architectural enhancements for MBS may be found in the in 3GPP Technical Specification (TS) 23.247 V17.1.0, the contents of which are incorporated herein by reference.

MBS employs shared tunnels for delivering user plane data (e.g. F1/NG user plane) to multiple UEs that have joined a particular service in order to benefit from a more efficient delivery of multicast/broadcast traffic. Thus, during session activation for MBS, a shared tunnel is established or if there is an already established shared tunnel for the given MBS, the tunnel is shared for the MBS session. When a UE joins an MBS service, an MBS session is established for that service on the user plane which is transmitted via the appropriate shared tunnel (using multicast). More specifically, traffic for the MBS service is transmitted using multicast, via the serving base station or a distributed unit thereof, over the shared user plane tunnel of that MBS service. Note that it is quite different to unicast which uses a dedicated user plane tunnel per UE.

In the current (Release 17) version of the 3GPP specifications, MBS via multicast is supported for UEs in Radio Resource Control (RRC) connected state. However, there is interest in extending multicast MBS support to UEs in RRC inactive state as well. However, this may have an impact on RRC inactive state mobility and state transitions since the current standards do not specify how to provide the necessary multicast configuration to the UEs for receiving multicast MBS data in RRC inactive state.

### SUMMARY OF INVENTION

### Technical Problem

The inventors have realised that the provision of MBS via multicast to UEs in RRC inactive state may be particularly difficult when using distributed base station units. Specifically, in Release 17, after a shared tunnel is established between the central unit and the distributed unit for an MBS service, the central unit delivers the associated data (PDCP PDUs) to the distributed unit. However, it is up to the distributed unit to decide whether to use unicast or multicast in the radio interface. Since only RRC connected UEs are supported for reception of MBS (both unicast and multicast) in Release 17, the distributed unit always has sufficient information (e.g. the number of UEs receiving or interested in receiving a particular MBS session via that distributed unit) to decide whether to use unicast or multicast in the cell of the distributed unit. However, the distributed unit does not have accurate information (or any information) regarding the number of RRC inactive UEs camping in the cell of the distributed unit, or the number of RRC inactive UEs interested in a particular MBS session, even if such information may be available in the central unit or a core network node. For example, a UE may enter the RRC connected state and join an MBS session in a cell of the distributed unit. Accordingly, at this stage, the distributed unit is aware of the existence of the UE and the MBS sessions received by the UE in the cell. However, once the UE transits to RRC inactive, the distributed unit no longer has this information (regardless of whether the UE has performed cell reselection or not). In another example, the distributed unit may not have the correct MBS related information due to mobility (cell reselection). Specifically, when the UE performs cell reselection to a cell of another base station (or distributed unit), neither the old base station nor the new base station can determine that the number of UEs camping in their respective cells have changed. Thus, they also cannot decide whether it is appropriate to use unicast or multicast in their cells. Moreover, a UE that has performed cell reselection may want to continue receiving the MBS multicast in the new cell without having to transition to RRC connected.

### Solution to Problem

Accordingly, the present disclosure seeks to provide methods and associated apparatus that address or at least alleviate (at least some of) the above-described issues.

In one aspect, the disclosure provides a method performed by a distributed unit of a base station apparatus for providing Multicast and Broadcast Services (MBS) in a cell for a user equipment (UE), the method comprising: receiving, from a central unit of the base station apparatus, in at least one of a UE context procedure or a multicast context procedure, information identifying at least one MBS session and identifying that the at least one MBS session is to be provided in the cell via multicast.

In one aspect, the disclosure provides a method performed by a central unit of a base station apparatus for providing Multicast and Broadcast Services (MBS) in a cell for a user equipment (UE), the method comprising: transmitting, to a distributed unit of the base station apparatus, in at least one of a UE context procedure or a multicast context procedure, information identifying at least one MBS session and identifying that the at least one MBS session is to be provided in the cell via multicast.

In one aspect, the disclosure provides a method performed by a distributed unit of a base station apparatus providing a Multicast and Broadcast Services (MBS) session for a user equipment (UE) in an inactive state, the method comprising: receiving, from an associated central unit, information indicating that a point-to-multipoint transmission associated with the MBS session is no longer mandated.

In one aspect, the disclosure provides a method performed by a central unit of a base station apparatus providing a Multicast and Broadcast Services (MBS) session for a user equipment (UE) in an inactive state, the method comprising: transmitting, to a distributed unit of the base station apparatus, information indicating that a point-to-multipoint transmission associated with the MBS session is no longer mandated.

In one aspect, the disclosure provides a method performed by a user equipment (UE), the method comprising: receiving a Multicast and Broadcast Services (MBS) session in an inactive state, using a point-to-multipoint transmission in a cell served by a distributed unit of a base station apparatus; performing cell reselection to a new cell; and transmitting, to a network node associated with the new cell, information indicating that the UE has performed the cell reselection.

In one aspect, the disclosure provides a method performed by a network node, the method comprising: receiving, from a user equipment (UE), information indicating that the UE has performed a cell reselection to a cell associated with the network node, in a case that a Multicast and Broadcast Services (MBS) session was provided to the UE in an inactive state, prior to the cell reselection, using a point-to-multipoint transmission in a cell served by a distributed unit of a base station apparatus.

In one aspect, the disclosure provides a method performed by a user equipment (UE), the method comprising: receiving information indicating whether at least one multicast session is provided in a cell; and performing a cell reselection based on the information for receiving, in an inactive state, the multicast session.

In one aspect, the disclosure provides a method performed by a base station, the method comprising: transmitting information indicating whether at least one multicast session is provided in a cell, for use by a user equipment (UE) in performing a cell reselection for receiving, in an inactive state, the at least one multicast session.

In one aspect, the disclosure provides a distributed unit of a base station apparatus for providing Multicast and Broadcast Services (MBS) in a cell for a user equipment (UE), the distributed unit comprising: means (for example a memory, a controller, and a transceiver) for receiving, from a central unit of the base station apparatus, in at least one of a UE context procedure or a multicast context procedure, information identifying at least one MBS session and identifying that the at least one MBS session is to be provided in the cell via multicast.

In one aspect, the disclosure provides a central unit of a base station apparatus for providing Multicast and Broadcast Services (MBS) in a cell for a user equipment (UE), the central unit comprising: means (for example a memory, a controller, and a transceiver) for transmitting, to a distributed unit of the base station apparatus, in at least one of a UE context procedure or a multicast context procedure, information identifying at least one MBS session and identifying that the at least one MBS session is to be provided in the cell via multicast.

In one aspect, the disclosure provides a distributed unit of a base station apparatus providing a Multicast and Broadcast Services (MBS) session for a user equipment (UE) in an inactive state, the distributed unit comprising: means (for example a memory, a controller, and a transceiver) for receiving, from an associated central unit, information indicating that a point-to-multipoint transmission associated with the MBS session is no longer mandated.

In one aspect, the disclosure provides a central unit of a base station apparatus providing a Multicast and Broadcast Services (MBS) session for a user equipment (UE) in an inactive state, the central unit comprising: means (for example a memory, a controller, and a transceiver) for transmitting, to a distributed unit of the base station apparatus, information indicating that a point-to-multipoint transmission associated with the MBS session is no longer mandated.

In one aspect, the disclosure provides a user equipment (UE) comprising: means (for example a memory, a controller, and a transceiver) for receiving a Multicast and Broadcast Services (MBS) session in an inactive state, using a point-to-multipoint transmission in a cell served by a distributed unit of a base station apparatus; means for performing cell reselection to a new cell; and means for transmitting, to a network node associated with the new cell, information indicating that the UE has performed the cell reselection.

In one aspect, the disclosure provides a network node comprising: means (for example a memory, a controller, and a transceiver) for receiving, from a user equipment (UE), information indicating that the UE has performed a cell reselection to a cell associated with the network node, in a case that a Multicast and Broadcast Services (MBS) session was provided to the UE in an inactive state, prior to the cell reselection, using a point-to-multipoint transmission in a cell served by a distributed unit of a base station apparatus.

In one aspect, the disclosure provides a user equipment (UE) comprising: means (for example a memory, a controller, and a transceiver) for receiving information indicating whether at least one multicast session is provided in a cell; and means for performing a cell reselection based on the information for receiving, in an inactive state, the multicast session.

In one aspect, the disclosure provides a base station comprising: means (for example a memory, a controller, and a transceiver) for transmitting information indicating whether at least one multicast session is provided in a cell, for use by a user equipment (UE) in performing a cell reselection for receiving, in an inactive state, the at least one multicast session.

Aspects of the disclosure extend to corresponding systems, apparatus, and computer program products such as computer readable storage media having instructions stored thereon which are operable to program a programmable processor to carry out a method as described in the aspects and possibilities set out above or recited in the claims and/or to program a suitably adapted computer to provide the apparatus recited in any of the claims.

Each feature disclosed in this specification (which term includes the claims) and/or shown in the drawings may be incorporated in the disclosure independently of (or in combination with) any other disclosed and/or illustrated features. In particular but without limitation the features of any of the claims dependent from a particular independent claim may be introduced into that independent claim in any combination or individually.

### BRIEF DESCRIPTION OF DRAWINGS

Embodiments of the disclosure will now be described, by way of example, with reference to the accompanying drawings in which:

FIG. 1 illustrates schematically a mobile (cellular or wireless) telecommunication system to which embodiments of the disclosure may be applied;

FIG. 2 illustrates schematically a mobile (cellular or wireless) telecommunication system to which embodiments of the disclosure may be applied;

FIG. 3 is a schematic block diagram of a mobile device forming part of the system shown in FIG. 1;

FIG. 4 is schematic block diagrams of an access network node (e.g. base station) forming part of the system shown in FIG. 1;

FIG. 5 is schematic block diagrams of an access network node (e.g. base station) forming part of the system shown in FIG. 1;

FIG. 6 is a schematic block diagram of a core network node forming part of the system shown in FIG. 1;

FIG. 7 is schematic signalling (timing) diagrams illustrating some exemplary embodiments of the present disclosure;

FIG. 8 is schematic signalling (timing) diagrams illustrating some exemplary embodiments of the present disclosure;

FIG. 9 is schematic signalling (timing) diagrams illustrating some exemplary embodiments of the present disclosure;

FIG. 10 is schematic signalling (timing) diagrams illustrating some exemplary embodiments of the present disclosure;

FIG. 11 is schematic signalling (timing) diagrams illustrating some exemplary embodiments of the present disclosure;

FIG. 12 is schematic signalling (timing) diagrams illustrating some exemplary embodiments of the present disclosure;

FIG. 13 is schematic signalling (timing) diagrams illustrating some exemplary embodiments of the present disclosure;

FIG. 14 is schematic signalling (timing) diagrams illustrating some exemplary embodiments of the present disclosure;

FIG. 15 is schematic signalling (timing) diagrams illustrating some exemplary embodiments of the present disclosure;

FIG. 16A is schematic signalling (timing) diagrams illustrating some exemplary embodiments of the present disclosure; and

FIG. 16B is schematic signalling (timing) diagrams illustrating some exemplary embodiments of the present disclosure.

### DESCRIPTION OF EMBODIMENTS

### Overview

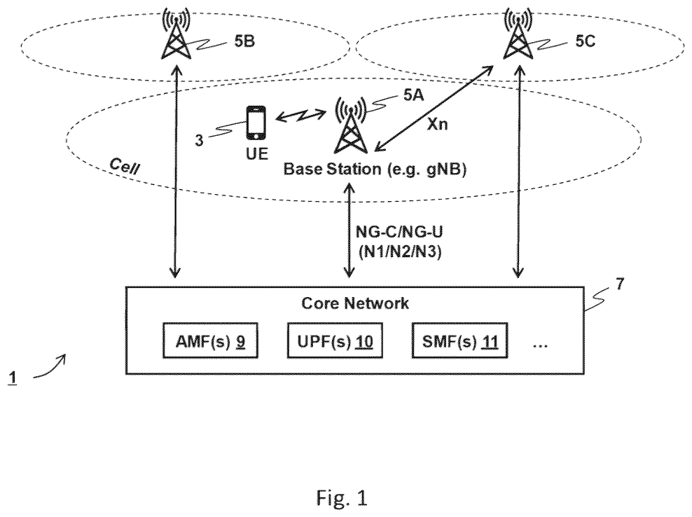

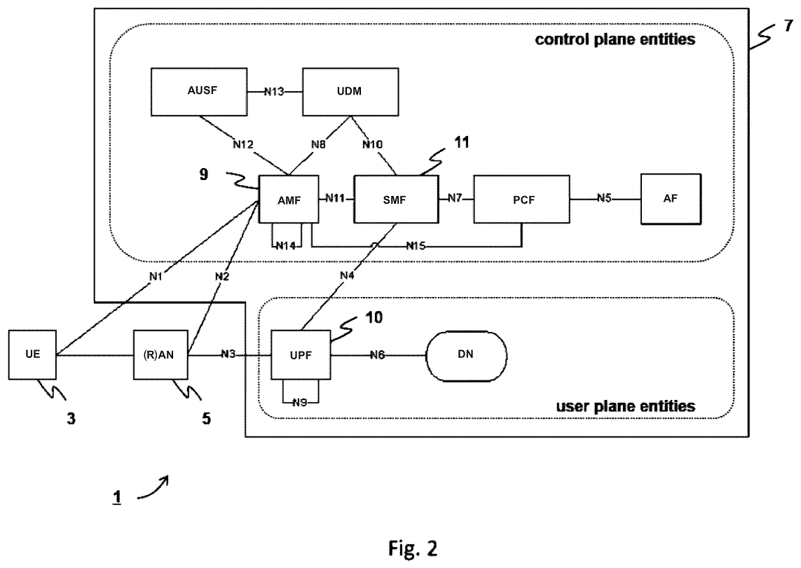

FIGS. 1 and 2 illustrate schematically a mobile (cellular or wireless) telecommunication system 1 to which embodiments of the disclosure may be applied.

In this system 1, users of mobile devices 3 (UEs) can communicate with each other and other users via base stations 5 (and other access network nodes) and a core network 7 using an appropriate 3GPP radio access technology (RAT), for example, an Evolved Universal Terrestrial Radio Access (E-UTRA) and/or 5G RAT. It will be appreciated that a number of base stations 5 form a (radio) access network or (R)AN. As those skilled in the art will appreciate, whilst one mobile device 3 and three base stations 5A-5C are shown in FIG. 1 for illustration purposes, the system, when implemented, will typically include other base stations/(R)AN nodes and mobile devices (UEs).

Each base station 5 controls one or more associated cells (either directly or via other nodes such as home base stations, relays, remote radio heads, distributed units, and/or the like). A base station 5 that supports Next Generation/5G protocols may be referred to as a ‘gNBs’. It will be appreciated that some base stations 5 may be configured to support both 4G and 5G, and/or any other 3GPP or non-3GPP communication protocols.

It will be appreciated that the functionality of a gNB 5 (referred to herein as a ‘distributed’ gNB) may be split between one or more distributed units (DUs) and a central unit (CU) with a CU typically performing higher level functions and communication with the next generation core and with the DU performing lower level functions and communication over an air interface with UEs in the vicinity (i.e. in a cell operated by the gNB). A distributed gNB includes the following functional units:
gNB Central Unit (gNB-CU): a logical node hosting Radio Resource Control (RRC), Service Data Adaptation Protocol (SDAP) and Packet Data Convergence Protocol (PDCP) layers of the gNB (or RRC and PDCP layers of an en-gNB) that controls the operation of one or more gNB-DUs. The gNB-CU terminates the so-called F1 interface connected with the gNB-DU.
gNB Distributed Unit (gNB-DU) 5D: a logical node hosting Radio Link Control (RLC), Medium Access Control (MAC) and Physical (PHY) layers of the gNB or en-gNB, and the operation of the gNB-DU is partly controlled by gNB-CU. One gNB-DU supports one or multiple cells. One cell is supported by only one gNB-DU. The gNB-DU terminates the F1 interface connected with the gNB-CU.
gNB-CU-Control Plane (gNB-CU-CP) 5C: a logical node hosting the RRC and the control plane part of the PDCP protocol of the gNB-CU for an en-gNB or a gNB. The gNB-CU-CP terminates the so-called El interface connected with the gNB-CU-UP and the F1-C (F1 control plane) interface connected with the gNB-DU.
gNB-CU-User Plane (gNB-CU-UP) 5U: a logical node hosting the user plane part of the PDCP protocol of the gNB-CU for an en-gNB, and the user plane part of the PDCP protocol and the SDAP protocol of the gNB-CU for a gNB. The gNB-CU-UP terminates the E1 interface connected with the gNB-CU-CP and the F1-U (F1 user plane) interface connected with the gNB-DU.

The mobile device 3 and the base station 5 are connected via an appropriate air interface (for example the so-called ‘NR’ air interface, the ‘Uu’ interface, and/or the like). Neighbouring base stations 5 are connected to each other via an appropriate base station to base station interface (such as the so-called ‘Xn’ interface, the ‘X2’ interface, and/or the like). The base stations 5 are also connected to the core network nodes via an appropriate interface (such as the so-called ‘NG-U’ interface (for user-plane), the so-called ‘NG-C’ interface (for control-plane), and/or the like).

The core network 7 (e.g. the EPC in case of LTE or the NGC in case of NR/5G) typically includes logical nodes (or ‘functions’) for supporting communication in the telecommunication system 1, and for subscriber management, mobility management, charging, security, call/session management (amongst others). For example, the core network 7 of a ‘Next Generation’/5G system will include user plane entities and control plane entities, such as one or more control plane functions (CPFs) and one or more user plane functions (UPFs). The so-called Access and Mobility Management Function (AMF) in 5G, or the Mobility Management Entity (MME) in 4G, is responsible for handling connection and mobility management tasks for the mobile devices 3. The so-called Session Management Function (SMF) is responsible for handling communication sessions for the mobile devices 3 such as session establishment, modification and release. In the example shown in FIG. 1, the core network 7 includes one or more AMF(s) 9, one or more UPF(s) 10, and one or more SMF(s) 11. It will be appreciated that the nodes or functions may have different names in different systems.

Further details of the core network 7 are shown in FIG. 2 which also shows the interfaces between respective network nodes or functions. As can be seen, the core network 7 may typically include an Authentication Server Function (AUSF), a Unified Data Management (UDM) entity, a Policy Control Function (PCF), an Application Function (AF), amongst others. The core network 7 is coupled (via the UPF 10) to a Data Network (DN), such as the Internet or a similar Internet Protocol (IP) based network. The core network 7 may also be coupled to an Operations and Maintenance (OAM) function (not shown).

In this system 1, Multicast and Broadcast Services (MBS) functionality is provided to UEs 3 via their serving base station 5 and associated core network nodes such as the UPF 10 and the SMF 11. The UPF 10 may be an MBS specific UPF in which case the UPF 10 may be referred to as the MB-UPF 10M (e.g. dedicated to the provision of MBS functionality). Similarly, the SMF 11 may be an MBS specific SMF in which case the SMF 11 may be referred to as the MB-SMF 11M. However, it will be appreciated that any suitable UPF 10/SMF 11 may be used for MBS.

MBS traffic is distributed over shared user plane tunnels, when appropriate. Specifically, MBS user plane data (e.g. F1-U/NG-U data) for a given MBS session is delivered over an associated shared tunnel, using multicast transmission, to those UEs that have joined that particular service.

When the first UE joins an MBS service, an MBS session is established for that service on the user plane between the core network 7 and the UE's serving base station 5 (and between units of a distributed gNB handling the user plane, if applicable). For any UE (at least one UE) interested in that MBS service, the MBS traffic can be transmitted via multicast, via a given serving base station or a distributed unit thereof, using the shared user plane tunnel.

In order to address various scenarios that may arise when a UE 3 in inactive state receives or is interested in receiving an MBS session via multicast (PTM) transmission, the following approaches may be taken.

For example, in a first scenario, the UE 3 may be initially in the RRC connected state when the UE 3 joins an MBS session in a cell of a distributed unit 5D (or when the UE 3 performs a handover to the cell whilst receiving the MBS session). Once the UE 3 moves to the RRC inactive state, the distributed unit 5D no longer has information regarding the MBS session(s) received by the UE 3 in the cell of the distributed unit 5D. The distributed unit 5D is also not aware of the current UE state (idle or inactive) or the cell selected by the UE 3 whilst in the RRC inactive state.

Beneficially, the distributed unit 5D may be notified regarding the UE's current RRC state and whether the UE 3 has performed a cell reselection, in order to determine whether to provide (continue to provide) a PTM service for the RRC inactive UEs 3 in the cell served by the distributed unit 5D. For example, the central unit 5C may notify the distributed unit 5D that an RRC inactive UE 3 is interested in (continuing to receive) an MBS service in a message for releasing the UE Context associated with the UE 3.

The central unit 5C may assist the distributed unit 5D to decide to switch to PTM (unicast) transmission for inactive UEs in the cell of the distributed unit 5D. For example, the central unit 5C may notify the distributed unit 5D that an RRC inactive UE 3 is interested in an MBS service (or interested in continuing to receive the MBS service) in a message for setting up or modifying a multicast context associated with the at least one MBS session. Effectively, the message may be used to configure the distributed unit 5D which MBS session is required to have PTM transmission turned on (‘always on’) or off for inactive UE(s) 3 in the cell of the distributed unit 5D.

In a second scenario, a UE 3 may be receiving an MBS session in RRC inactive state in a first cell. When the UE 3 performs cell-reselection to a second cell (which may be served by a neighbour base station 5), the distributed unit 5D may be notified that an RRC inactive UE has performed cell reselection. This information may be used for the distributed unit 5D to decide whether to provide PTM transmission in the cell of the distributed unit 5D for a particular MBS session. For example, the UE 3 may be configured to perform a RAN notification area update procedure, a registration procedure, or small data transmission (SDT) to inform the new base station 5 about the cell reselection. The new base station 5 contacts the UE's access and mobility function which may notify the old distributed unit 5D (via the central unit 5C) that the inactive UE 3 (previously served by the distributed unit 5D) has left the cell. The central unit 5C may instruct the distributed unit 5D to turn off/deactivate the multicast/PTM transmission in the cell of the distributed unit 5D.

In a third scenarios, which may be in combination with the first and/or second scenario, the UE 3 is configured to obtain information relating to the provision of MBS sessions in neighbour cells to assist the UE's cell reselection. For example, the serving base station 5/distributed unit 5D may identify the frequencies used by neighbour cells and the UE 3 may obtain system information from the neighbour cells, such as an appropriate indication identifying whether PTM is always on in a particular neighbour cell, and information identifying any MBS service provided via multicast/PTM in that cell. Alternatively, this information may be provided by the serving base station 5/distributed unit 5D (together with information identifying the frequencies used by neighbour cells and/or the associated cell identifiers). Based on the indication that multicast/PTM is used in a cell, and based on the MBS services provided in that cell, the UE 3 is able to prioritise those cells that provide multicast for the MBS service(s) that the UE 3 is interested in.

### User Equipment (UE)

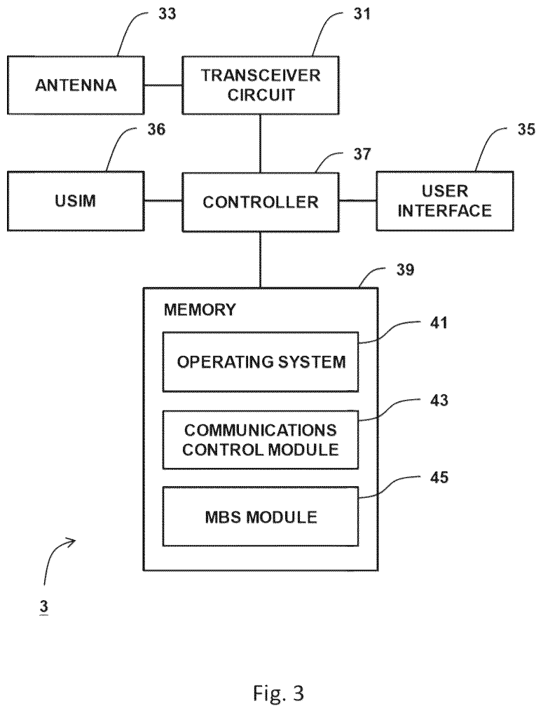

FIG. 3 is a block diagram illustrating the main components of the mobile device (UE) 3 shown in FIG. 1. As shown, the UE 3 includes a transceiver circuit 31 which is operable to transmit signals to and to receive signals from the connected node(s) via one or more antenna 33. Although not necessarily shown in FIG. 3, the UE 3 will of course have all the usual functionality of a conventional mobile device (such as a user interface 35) and this may be provided by any one or any combination of hardware, software and firmware, as appropriate. A controller 37 controls the operation of the UE 3 in accordance with software stored in a memory 39. The software may be pre-installed in the memory 39 and/or may be downloaded via the telecommunication network 1 or from a removable data storage device (RMD), for example. The software includes, among other things, an operating system 41, a communications control module 43 and an MBS module 45.

The communications control module 43 is responsible for handling (generating/sending/receiving) signalling messages and uplink/downlink data packets between the UE 3 and other nodes, including (R)AN nodes 5 and core network nodes. The signalling may comprise RRC signalling (to/from the (R)AN nodes 5) and/or NG-C/NG-U signalling (to/from the core network 7).

The MBS module 45 is responsible for handling signalling (control signalling and/or MBS traffic) relating to multimedia broadcast services, including signalling relating to the provision of multimedia broadcast services via multicast for the UE 3 in inactive state.

### Access Network Node (Base Station)

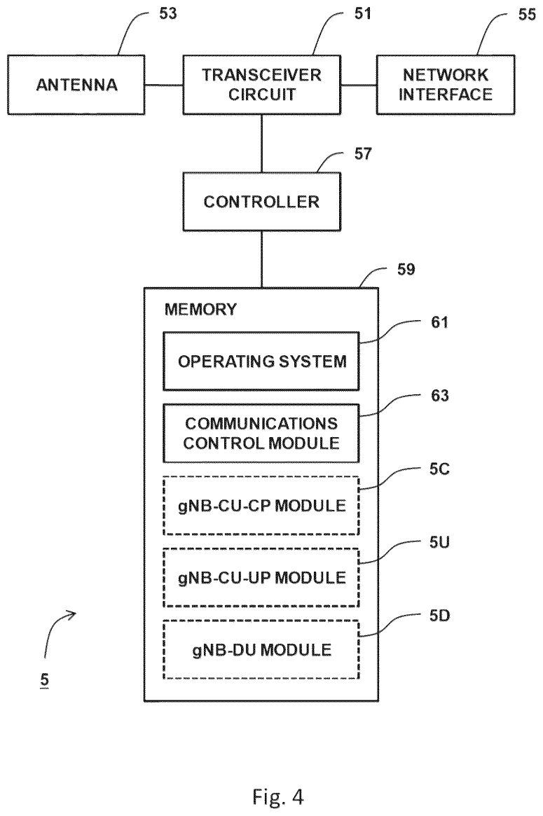

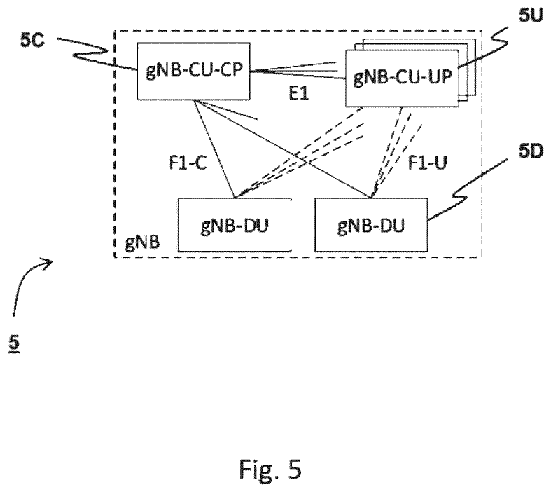

FIGS. 4 and 5 are block diagrams illustrating the main components of a base station 5 (or a similar access network node) shown in FIG. 1. As shown in FIG. 4, the base station 5 has a transceiver circuit 51 for transmitting signals to and for receiving signals from user equipment (such as the mobile device 3) via one or more antenna 53, a network interface 55 for transmitting signals to and for receiving signals from the core network 7 and neighbouring base stations. The base station 5 has a controller 57 to control the operation of the base station 5 in accordance with software stored in a memory 59. The software may be pre-installed in the memory 59 and/or may be downloaded via the telecommunication network 1 or from a removable data storage device (RMD), for example. The software includes, among other things, an operating system 61, and at least a communications control module 63. Although not shown in FIG. 4, the network interface 55 will also typically include a base station to base station interface portion (e.g. Xn and/or the like), and a core network interface portion (e.g. NG-C/NG-U/N2/N3).

The communications control module 63 is responsible for handling (generating/sending/receiving) signalling between the base station 5 and other nodes, such as the UE 3 and the core network nodes. Such signalling may include, for example, control data for managing operation of the mobile device 3 (e.g. Non-Access Stratum, Radio Resource Control, system information, paging, and/or the like). The communications control module 63 is also responsible for handling signalling relating to multimedia broadcast services (control signalling and/or MBS traffic), including signalling relating to the provision of MBS via multicast for UEs 3 in inactive state.

It will be appreciated that the communications control module 63 may include a number of sub-modules (or ‘layers’) to support specific functionalities. For example, the communications control module 63 may include a PHY sub-module, a MAC sub-module, an RLC sub-module, a PDCP sub-module, an SDAP sub-module, an IP sub-module, an RRC sub-module, etc.

As shown in FIG. 5, when the base station 5 comprises a distributed gNB or en-gNB, the network interface 55 also includes an E1 interface and an F1 interface (F1-C for control plane and F1-U for user plane) to communicate signals between respective functions of the distributed gNB or en-gNB. In this case, the software also includes at least one of: a gNB-CU-CP module 5C, a gNB-CU-UP module 5U, or a gNB-DU module 5D. If present, the gNB-CU-CP module 5C hosts the RRC layer and the control plane part of the PDCP layer of the distributed gNB or en-gNB. If present, the gNB-CU-UP module 5U hosts the user plane part of the PDCP and the SDAP layers of the distributed gNB or the user plane part of the PDCP layer of the distributed en-gNB. If present, the gNB-DU module 5D hosts the RLC, MAC, and PHY layers of the distributed gNB or en-gNB.

It will be understood by a person skilled in the art that the central unit (e.g. 5C and/or 5U) may be implemented and physically located with the base station or may be implemented at a remote location, as a single physical element or as a cloud-based or virtualised system. It will also be understood that a single central unit may serve multiple base stations 5.

### Core Network Node

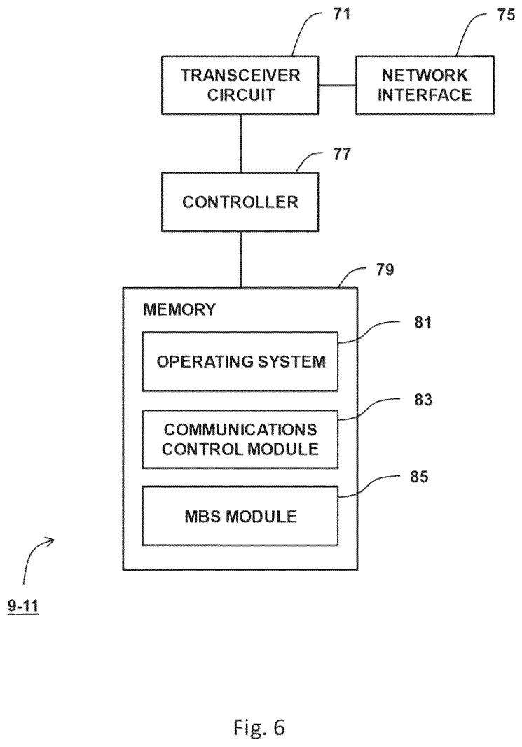

FIG. 6 is a block diagram illustrating the main components of a core network node shown in FIG. 1 (e.g. the AMF 9, the UPF 10, or the SMF 11). As shown, the core network node includes a transceiver circuit 71 which is operable to transmit signals to and to receive signals from connected UE(s) 3 via one or more antenna 73 and to transmit signals to and to receive signals from other network nodes (either directly or indirectly) via a network interface 75. Signals may be transmitted to and received from the UE(s) 3 either directly and/or via the base station 5 or other (R)AN nodes, as appropriate. The network interface 75 typically includes an appropriate base station interface (such as S1/NG-C/NG-U). A controller 77 controls the operation of the core network node in accordance with software stored in a memory 79. The software may be pre-installed in the memory 79 and/or may be downloaded via the telecommunication network 1 or from a removable data storage device (RMD), for example. The software includes, among other things, an operating system 81, a communications control module 83, and an MBS module 85 (optional).

The communications control module 83 is responsible for handling (generating/sending/receiving) signalling between the core network node and other nodes, such as the UE 3, (R)AN nodes, and other core network nodes.

If present, e.g. in an MB-SMF or MB-UPF, the MBS module 85 is responsible for handling signalling relating to multimedia broadcast services (control signalling and/or MBS traffic), including signalling relating to the provision of MBS via multicast for UEs 3 in inactive state.

### Detailed Description

The following is a description of some exemplary procedures performed by the nodes of the system shown in FIGS. 1 and 2 to support MBS sessions for UEs in the RRC inactive state.

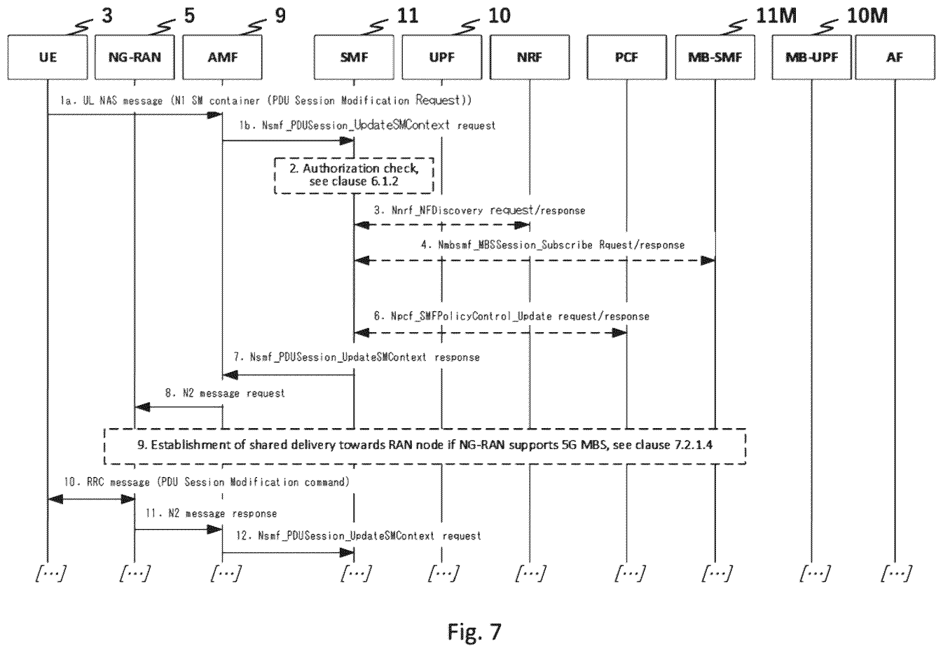

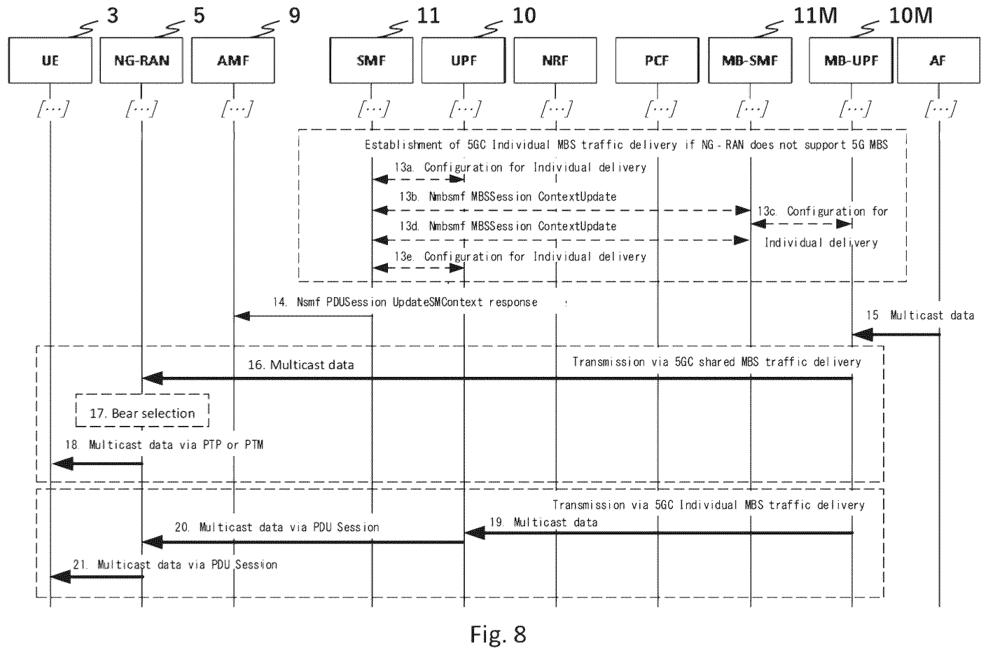

Before discussing these procedures in detail, this is a short overview of a Protocol Data Unit (PDU) session modification procedure for a UE 3 joining a multicast session MBS reception. The procedure is illustrated in FIGS. 7 and 8 which are based on FIG. 7.2.1.3-1 of 3GPP TS 23.247 V17.2.0. The procedure may be followed for example when the UE 3 wishes to receive an MBS service for the first time, before entering RRC inactive state. Although not shown, it will be appreciated that the following steps may have been executed before the UE 3 requests to join an MBS session:
the MBS Session has been created in the core network 7;
the UE 3 knowns at least the identifier of the MBS session (MBS Session ID) of a multicast group that the UE can join (the identifier may be provided to the UE 3 e.g. via an appropriate service announcement); and
the UE 3 is registered in the network and may have established a PDU session that can be associated with multicast session(s).

When the first UE 3 in RRC connected state joins an MBS session, the core network 7 (5GC) triggers the MBS session establishment procedure, as specified in clause 7.2.1 of 3GPP TS 23.247 (entitled ‘MBS join and Session establishment procedure’). Using this procedure, the UE 3 informs the core network 7 of the UE's interest in joining a multicast MBS session. The first accepted UE join request triggers establishment of a multicast MBS session towards the radio access network (serving base station 5) and the UE 3. As can be seen in steps 15 to 18 of FIG. 8, multicast data is delivered using an MBS specific UPF, referred to as the MB-UPF 10M. Between the radio access network (serving base station 5) and the UE 3, the multicast data may be transmitted using either a point-to-point (PTP) bearer or a point-to-multipoint (PTM) bearer, as generally shown in step 18. If multicast delivery is not supported throughout the network, then the multicast data is transmitted using a UE specific PDU session, via the associated UPF 10, as generally shown in steps 19 to 21. However, this delivery method is less efficient, especially in case of multiple UEs 3 interested in the same MBS session as the multicast data needs to be delivered individually to each UE 3 using their associated PDU session and UPF 10, rather than using a shared tunnel (e.g. between the MB-UPF 10M and the base station 5/distributed unit 5D) and a common (PTM) bearer.

### Scenario 1

In this case, the UE 3 may be initially in the RRC connected state when the UE 3 joins an MBS session in a cell of the distributed unit 5D (or when the UE 3 performs a handover to the cell whilst receiving the MBS session). Accordingly, at this stage, the distributed unit 5D is aware of the existence of the UE 3 and the MBS session(s) received by the UE 3 in the cell managed by the distributed unit 5D. Once the UE 3 moves to the RRC inactive state, the distributed unit 5D no longer has this information.

RRC is controlled by the central unit 5C. Thus, when the UE 3 transits between RRC states, the central unit 5C is aware of the current UE state. However, the distributed unit 5D is not aware of the current UE state or the cell selected by the UE 3 whilst in the RRC inactive state.

The only thing that the distributed unit 5D knows is that the UE Context has been released by the central unit 5C, but the distributed unit 5D does not know whether the UE 3 has moved to the RRC idle state or the RRC inactive state (in which the UE 3 may still be able to receive MBS using multicast).

The following is a description of some of the ways in which the distributed unit 5D may be notified regarding the UE's current RRC state and whether the UE 3 has performed a cell reselection, in order to determine whether to provide a PTM service for the RRC inactive UEs 3 in the cell served by the distributed unit 5D.

For example, when three UEs 3 are receiving an MBS service in RRC connected state, the distributed unit 5D may decide to use a respective PTP bearer for each UE 3. When one of the UEs 3 that is still interested in the MBS session enters the RRC inactive state, the distributed unit 5D needs to know about the UE 3 entering the RRC inactive state so that the distributed unit 5D can set up PTM transmission for the RRC inactive UE 3.

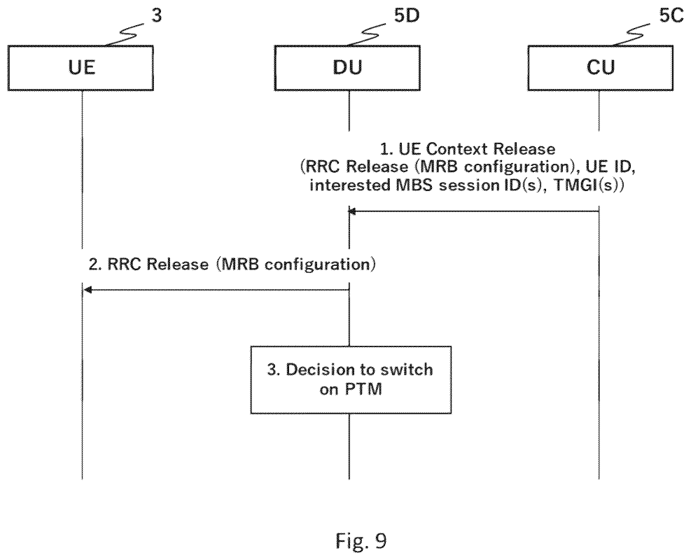

FIG. 9 is a signalling (timing) diagram illustrating schematically a procedure for assisting the distributed unit 5D to decide to switch to PTM (unicast) transmission for inactive UEs in the cell of the distributed unit 5D. In this case, the central unit 5C notifies the distributed unit 5D that an RRC inactive UE 3 is interested in (continuing to receive) an MBS service in a message for releasing the UE Context associated with the UE 3.

Step 1: the central unit 5C sends a message for releasing the UE Context associated with the UE 3 to the distributed unit 5D. The message (e.g. a UE Context Release Request and/or the like) includes information identifying the UE 3 (UE ID), information identifying at least one MBS session that the UE 3 is interested in (MBS session ID/TMGI), and the appropriate PTM multicast radio bearer (MRB) configuration(s) for the MBS session(s). For example, the PTM MRB configuration(s) may be included in a message for releasing the UE Context associated with the UE 3 (e.g. a UE Context Release message and/or the like). The RRC release message may be included in the message for releasing the UE Context (as shown in FIG. 9), or may be sent separately. Based on the MBS session information received from the central unit 5C, the distributed unit 5D knows which MBS service(s) the UE 3 will (continue to) receive after the UE 3 has moved to the RRC inactive mode.

Step 2: the RRC release (which includes the appropriate PTM MRB configuration from the central unit 5C for the MBS session) is sent from the distributed unit 5D to the UE 3. The UE 3 obtains the PTM MRB configuration from RRC release message. Note: the PTM MRB configuration for establishing the PTM MRB will typically include the appropriate PDCP, RLC, MAC, Multicast/MBS Control Channel (MCCH), and Multicast/MBS Traffic Channel (MTCH) configuration.

Step 3: the distributed unit 5D decides that the PTM transmission is always turned on for the inactive UE(s) 3 in the cell of the distributed unit 5D (when the distributed unit 5D determines based on the information included in the UE context release message that there is at least one inactive UE in the cell of the distributed unit 5D). The decision may be based on for example the number of UEs 3 reaching or exceeding an associated threshold (which may be ‘1’ inactive UE). It will be appreciated that a different (higher) threshold may be used when deciding whether to use PTM for connected UEs 3 in the cell.

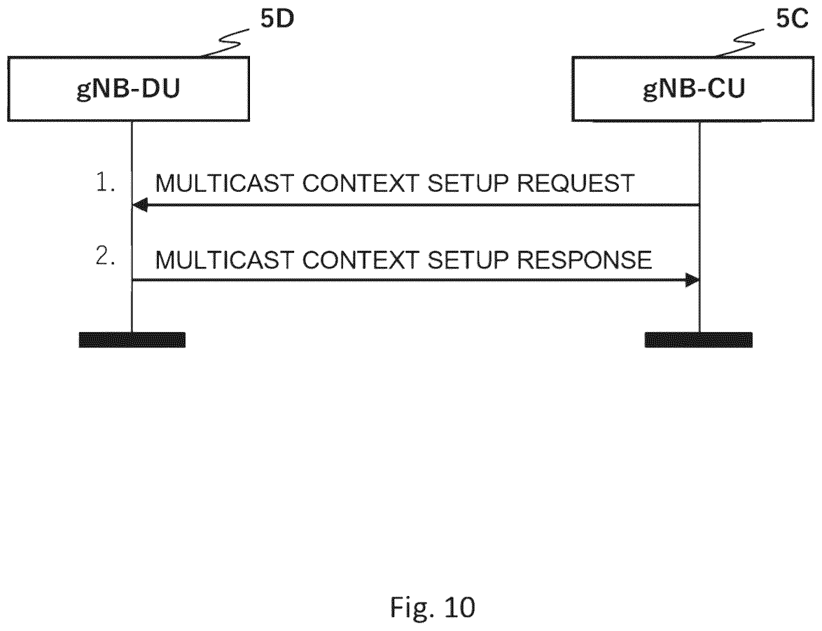

FIG. 10 is a signalling (timing) diagram illustrating schematically another procedure for assisting the distributed unit 5D to decide to switch to PTM (unicast) transmission for inactive UEs in the cell of the distributed unit 5D.

In this case, the central unit 5C notifies the distributed unit 5D that an RRC inactive UE 3 is interested in an MBS service (or interested in continuing to receive the MBS service) in a message for setting up or modifying a multicast context associated with the at least one MBS session. Such a message is illustrated in step 1 of FIG. 10. Effectively, the central unit 5C configures the distributed unit 5D which MBS session is required to have PTM transmission turned on for inactive UE(s) 3 in the cell of the distributed unit 5D. This is realised by including appropriate information in the message sent in step 1. The information may be an indication relating to PTM such as an indication whether PTM is to be turned on (always on) or an indication that PTM can be off in the cell. In the specific case shown in FIG. 10, the Multicast Context Setup Request is adapted to include the indication identifying whether PTM should be on or off. It will be appreciated that a Multicast Context Modification Request message may be adapted in a similar way (in case there is an existing multicast context).

The indication may be in the form of a ‘PTM always on’ indication (or similar), in which case the distributed unit 5D knows that there is at least one UE 3 in RRC inactive mode that is interested in MBS session. In other words, this type of indication may need to be sent at least for the first inactive UE 3 in the cell of the distributed unit 5D (although this type of indication may be sent for any subsequent UEs as well).

The indication may be in the form of a ‘PTM can be off’ indication in which case the central unit 5C knows that there is no inactive UE 3 in the cell of the distributed unit 5D that is still interested in receiving the MBS session. In this case, therefore, the distributed unit 5D doesn't necessarily need to provide (or continue to provide) the PTM transmission in the cell of the distributed unit 5D, for that particular MBS service.

It will be appreciated that in this case, the base station 5 may provide the appropriate PTM MRB configuration for the MBS session to the UE 3 in the RRC release message as described above with reference to FIG. 9. Alternatively, the PTM MRB configuration may be provided using a system information block. For example, the system information may include the PTM MRB configuration itself, or include information for receiving the MCCH and the relevant PTM MRB configuration (e.g. PDCP, RLC, MAC, MTCH configuration) for each MBS session may be notified via the MCCH.

In summary, the distributed unit (that provides MBS in the cell of the distributed unit) receives, from the central unit, information identifying at least one MBS session and information identifying that the at least one MBS session is to be provided in the cell via multicast (using point-to-multipoint transmission) for a user equipment (UE) in an inactive state. The information may be included in an appropriately formatted UE context release message, which may also include a further message for releasing the UE to the inactive state. The further message may include the information for configuring a respective multicast radio bearer for the at least one MBS session. Alternatively, the information for configuring the multicast radio bearer may be included in a message for setting up or modifying a multicast context associated with the at least one MBS session. The distributed unit may transmit, to the UE, configuration information for configuring a respective multicast radio bearer for receiving the at least one MBS session in the inactive state (e.g. in a message for releasing a connection of the UE; in a system information block; or via a multicast control channel). The configuration information makes it possible for the UE in RRC inactive state to use multicast for receiving the at least one MBS session.

### Scenario 2

The following is a discussion of another MBS related scenario, specifically, some of the ways in which the distributed unit 5D may be notified that an RRC inactive UE has performed cell reselection. This information may be used by the distributed unit 5D to decide whether to provide PTM transmission in the cell of the distributed unit 5D for a particular MBS session.

Initially, a UE 3 may be receiving an MBS session in RRC inactive state in a first cell. The UE 3 may have obtained the relevant PTM MRB configuration as described above. At one point, the UE 3 may perform cell-reselection to a second cell (which may be served by a neighbour base station 5). Normally, if the tracking area of the second cell is in the UE's tracking area list, the UE 3 does not perform a registration change procedure. In other words, the UE 3 camps on the second cell and remains in RRC inactive state.

In this scenario, if this UE 3 is the last RRC inactive UE in the first (source) cell, then the source distributed unit 5D does not know that there are no more RRC inactive UEs interested in the MBS service. It may result in a waste of resources since the source distributed unit 5D has to keep the PTM transmission alive (always on) in the cell of the distributed unit 5D. If there are only RRC connected UEs 3 interested in that particular MBS session, it may be more appropriate for the source distributed unit 5D to use PTP transmission for those UEs 3 (depending on the number or UEs and/or their capability, amongst others).

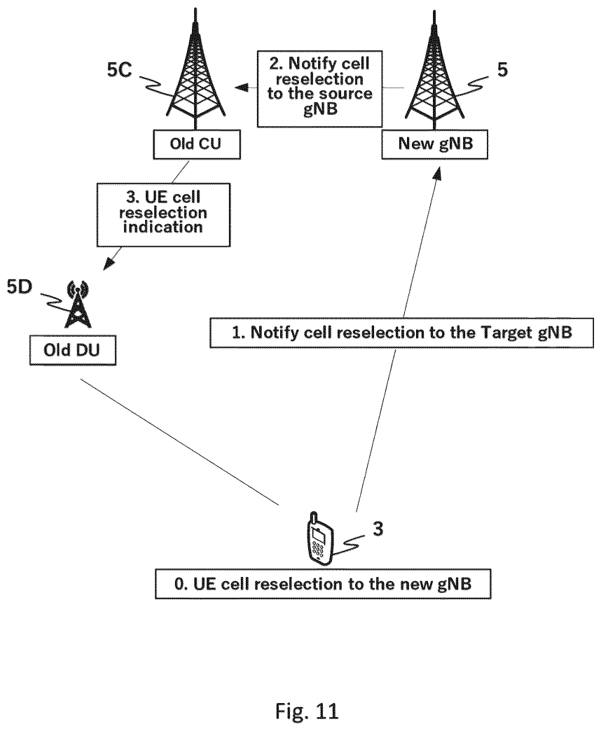

Thus, in order to help the distributed unit 5D make an appropriate decision regarding MBS multicast in the cell of the distributed unit 5D, the following procedures may be used, which will be described with reference to FIGS. 11 to 16.

FIG. 11 is a signalling (timing) diagram illustrating schematically a procedure for notifying a distributed unit 5D that an inactive UE (previously served by the distributed unit 5D) has left the cell of the distributed unit 5D.

In more detail, whilst receiving an MBS session via the cell of the distributed unit 5D (referred to as ‘Old DU’ in FIG. 11), the UE 3 performs a cell reselection to a cell served by another base station 5 (denoted ‘New gNB’ in FIG. 11). Then, in step 1, the UE 3 notifies the new base station 5 that the UE 3 has performed cell reselection. For example, the information indicating that the UE 3 has performed the cell reselection may be included in at least one of: a registration request message, a resume request message, a radio access network (RAN) notification area update message, or a small data transmission message. In step 2, the new base station 5 notifies the old base station (the central unit 5C thereof), via the base station to base station interface between them, that the UE 3 has performed cell reselection to a cell of the new base station 5. The central unit 5C forwards this indication to the distributed unit 5D in step 3, which allows the distributed unit 5D to make an appropriate decision regarding whether to maintain the multicast transmission for the relevant MBS session(s) or to release the associated MRB.

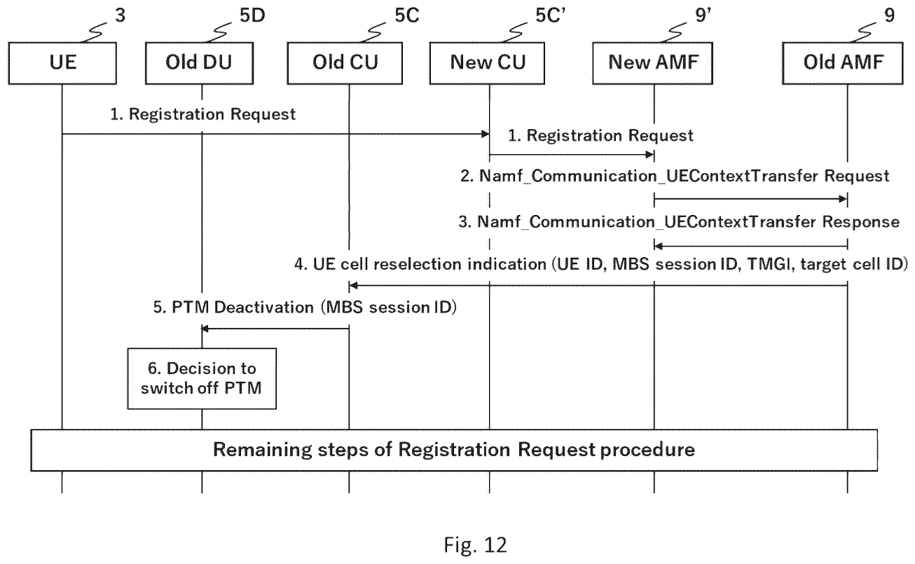

FIG. 12 is a signalling (timing) diagram illustrating schematically an exemplary procedure for notifying a distributed unit 5D that an inactive UE 3 has left the cell of the distributed unit 5D. In this case, the new base station 5 determines that the UE 3 has performed a cell reselection in a registration procedure initiated by the UE 3 and informs the distributed unit 5D.

The UE 3 is initially in the RRC inactive state and receives an MBS session using an associated MRB configuration in a cell of the distributed unit 5D (denoted ‘Old DU’ in FIG. 12). Accordingly, there is a multicast MBS transmission taking place in the cell of the distributed unit 5D.

The UE 3 performs cell reselection, then generates and sends, in step 1, an appropriately formatted message to register the new cell of the UE 3 with a mobility and access management function (in this case the new AMF 9′ associated with the new cell). The new AMF 9′ and the AMF 9 associated with the UE's old cell perform an appropriate UE context transfer procedure, as generally shown in steps 2 and 3. It will be appreciated that the new AMF 9′ may be the same as the AMF 9 associated with the UE's old cell, in which case there is no need to perform a UE context transfer (i.e. steps 2 and 3 may be omitted). At this point, the UE's old distributed unit 5D does not know about the cell reselection.

Beneficially, the AMF 9 is configured to notify the central unit 5C that the UE 3 has performed a cell reselection and left the cell of the distributed unit 5D associated with this central unit 5C. This notification may be sent upon reception of the message in step 2 or upon reception of the registration request in step 1 (if there is no AMF change).

In step 5, the central unit 5C notifies the distributed unit 5D that the PTM transmission can be stopped. It will be appreciated that step 5 may be performed only after the central unit 5C has determined that there are no more inactive UEs 3 left in the cell that are interested in the given MBS session.

If appropriate, based on the notification received in step 5, the source distributed unit 5D confirms in step 6 that the UE 3 in question was the last inactive UE 3 interested in the MBS service, and the source distributed unit 5D may decide to switch off the PTM transmission in the cell.

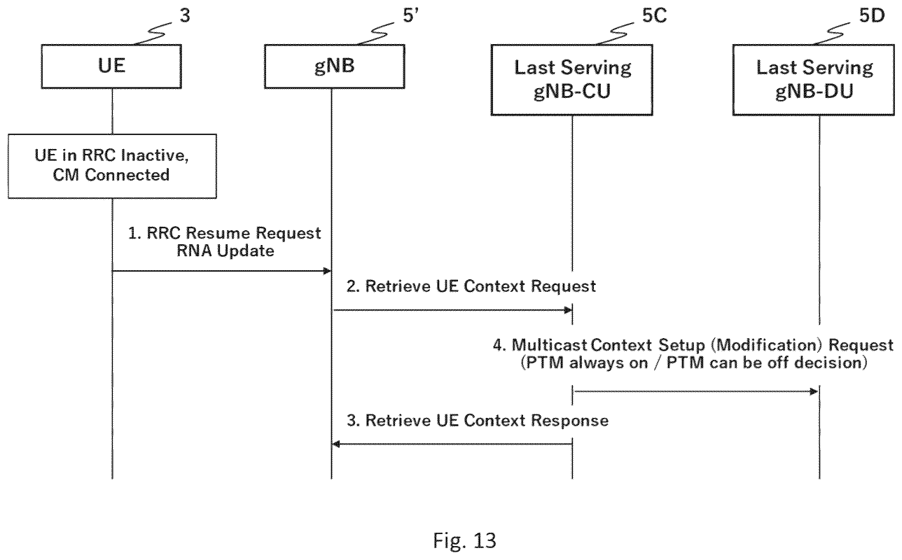

FIG. 13 is a signalling (timing) diagram illustrating schematically an exemplary procedure for notifying a distributed unit 5D that an inactive UE 3 has left the cell of the distributed unit 5D. In this case, the new base station 5 determines that the UE 3 has performed a cell reselection in RAN notification area update procedure initiated by the UE 3 and informs the distributed unit 5D.

As shown, the UE 3 is initially in the RRC inactive state and in a Connection Management (CM) connected state, whilst receiving an MBS session via PTM in a cell of a distributed unit 5D (denoted ‘Last Serving gNB-DU’ in FIG. 13).

In this case, following a cell reselection to a new cell served by a new base station 5′, the UE 3 performs an appropriate RAN notification area update procedure to inform the new base station 5′ about the cell reselection. Therefore, in step 1, the UE 3 generates and sends an appropriately formatted RRC resume request (requesting to resume the inactive RRC connection at the new base station 5′). The request also includes a RAN notification area update. In step 2, the new base station 5′ contacts the central unit 5C of the UE's old base station (denoted ‘Last Serving gNB-CU’ in FIG. 13) in order to retrieve the UE context associated with the UE 3. Upon receiving this message, the central unit 5C generates and sends, in step 4, an appropriately formatted Multicast Context Setup Request (e.g. as described above with reference to FIG. 10) or a Multicast Context Modification Request message, and includes in this message an indication identifying whether PTM should be on or off in the cell of the distributed unit 5D.

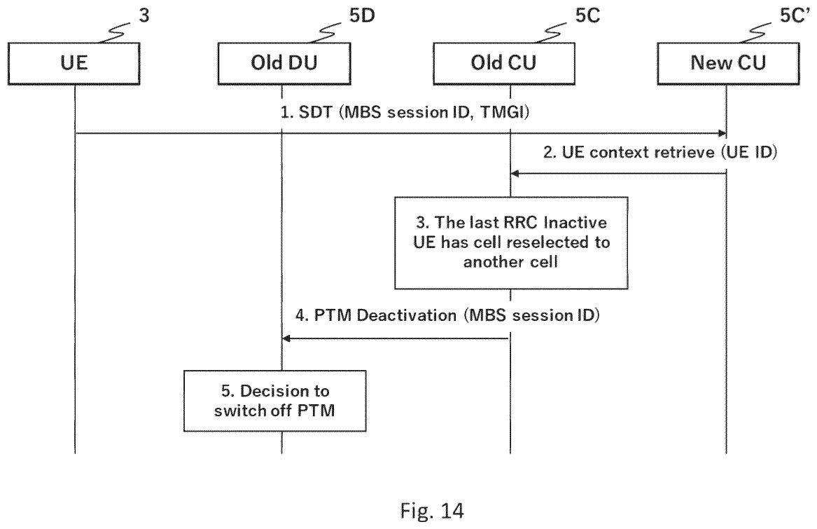

FIG. 14 is a signalling (timing) diagram illustrating schematically an exemplary procedure for notifying a distributed unit 5D that an inactive UE 3 has left the cell of the distributed unit 5D. In this case, the UE 3 does not need to perform a RAN notification area update procedure or a registration procedure (e.g. in a case that the tracking area of the new cell is in the tracking area list of the UE 3).

In this case, the UE 3 is configured to performs a small data transmission (SDT) to inform the new base station (new central unit 5′ in FIG. 14) about the cell reselection.

In more detail, before this procedure, the UE 3 is in the RRC inactive state and receives an MBS session via PTM in a cell of a distributed unit 5D (denoted ‘Old DU’ in FIG. 14). When the UE 3 performs a cell reselection, the UE 3 sends, in step 1, information identifying the MBS session(s) (by their associated MBS session ID(s) and/or TMGI(s)) to the new base station/central unit 5′ using an SDT message. Upon receipt of this message, the new central unit 5′ contacts, in step 2, the central unit 5C of the UE's old base station (denoted ‘Old CU’ in FIG. 14) in order to retrieve the UE context associated with the UE 3.

In step 3, the old central unit 5C determines, based on the message from the new central unit 5C′, that the UE 3 in question has performed a cell reselection to another cell.

In step 4, if the old central unit 5C determines that this particular UE 3 was the last inactive UE receiving an MBS session in the cell of the old distributed unit 5D via multicast/PTM, the old central unit 5C instructs the old distributed unit 5D to deactivate the associated PTM transmission, if appropriate. It will be appreciated, however, that there might be RRC connected UEs receiving the same session, in which case the distributed unit 5D may decide to continue using PTM transmission for those UEs.

If the old distributed unit 5D confirms that the UE 3 was the last UE interested in the MBS service, the old distributed unit 5D may decide to switch off PTM in the cell, in step 5.

### Scenario 3

Referring to FIG. 8 again, the central unit 5C sends PDCP PDUs to the distributed unit 5D, as shown in step 16. It is up to the distributed unit 5D to decide whether to map the received PDCP PDUs to a PTM leg or a PTP leg (between the distributed unit 5D and the UE 3), as shown in step 18. This is a dynamic decision of the distributed unit 5D, and the distributed unit 5D does not need to notify the central unit 5C about the decision. The decision changes from time to time, from UE to UE, and from MBS session to MBS session. It follows therefore that the UE 3, which has a control plane connection with the central unit 5C, also cannot know whether a cell, such as a neighbour cell, uses PTM or PTP in the last leg, for an MBS session that the UE 3 is interested in.

The following is a description of some exemplary ways in which this information may be provided to the UE 3.

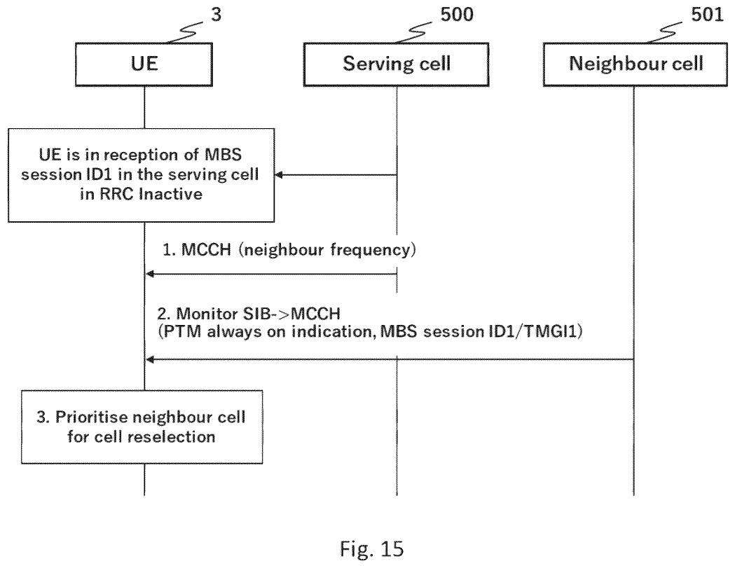

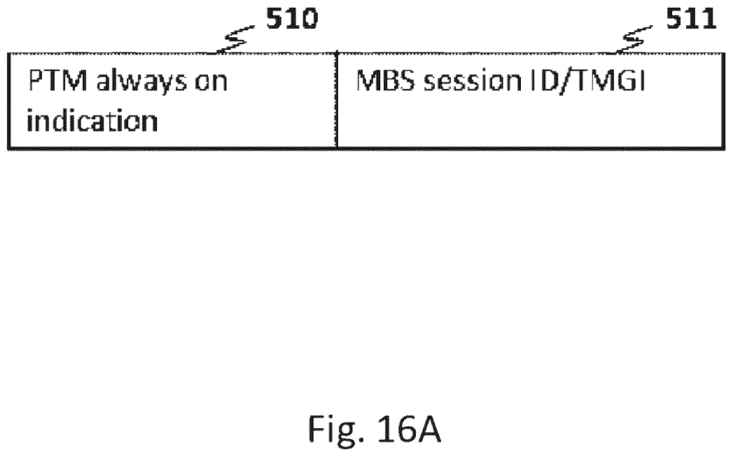

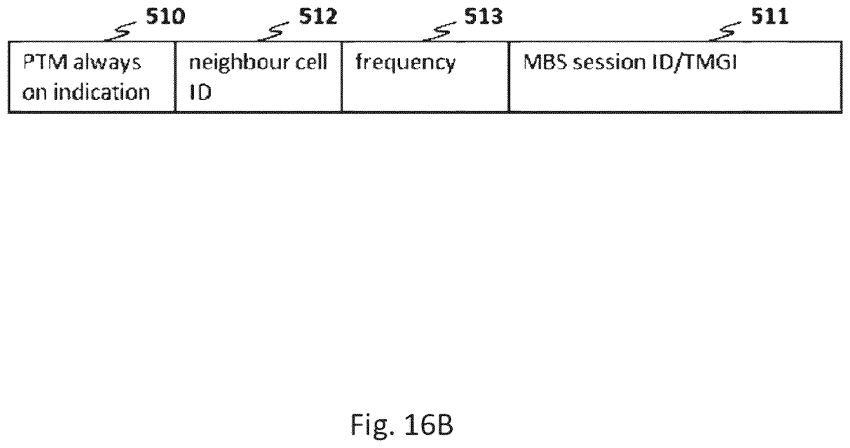

In a first option, which is illustrated in FIGS. 15 and 16 (a), the serving base station 5 (serving cell 500) indicates the frequencies of the neighbour cells 501 to the UE 3. Specifically, as shown in step 1 of FIG. 15, the serving cell 500 transmits, via the MCCH, information identifying the neighbour frequencies.

In step 2, the UE 3 monitors the identified frequencies and obtains system information from the neighbour cell(s) 501, at least a part of the system information or system information blocks relating to the MCCH in the neighbour cell(s) 501. The system information/MCCH of the neighbour cell(s) 501 includes an appropriate indication identifying whether PTM is always on in the cell 501, and information identifying any MBS service provided via multicast/PTM. The information is shown in more detail in FIG. 16A.

Based on this indication and the MBS services identified, the UE 3 is able to prioritise those cells 501 that provide multicast for the MBS service(s) that the UE 3 is interested in.

It will be appreciated that if there is any RRC inactive UE receiving MBS service in the neighbour cell 501, the neighbour cell 501 will continue to transmit multicast data by PTM for those UEs, and continue to broadcast the PTM always on indication, associated with an MBS session ID or TMGI.

In another option, which is shown in FIG. 16B, the serving cell 500 may be configured to send PTM related information associated with the neighbour cell(s) 501. For example, for each neighbour cell 501, the serving cell 500 may broadcast an associated PTM always on indication, an associated with cell ID, information identifying the frequency used, and at least one MBS session ID or TMGI. The information may be transmitted in the MCCH or one or more system information block in the cell 500.

### Modifications and Alternatives

Detailed embodiments have been described above. As those skilled in the art will appreciate, a number of modifications and alternatives can be made to the above embodiments whilst still benefiting from the disclosures embodied therein. By way of illustration only a number of these alternatives and modifications will now be described.

It will be appreciated that cell reselection may trigger either a RAN notification area update or a registration update, depending on the selected cell. Accordingly, the UE may initiate either the procedure shown in FIG. 12 or the procedure shown in FIG. 13, depending on the selected cell.

Whilst a base station of a 5G/NR communication system is commonly referred to as a New Radio Base Station (‘NR-BS’) or as a ‘gNB’, it will be appreciated that they may be referred to using the term ‘eNB’ (or 5G/NR eNB) which is more typically associated with Long Term Evolution (LTE) base stations (also commonly referred to as ‘4G’ base stations). 3GPP TS 38.300 V16.7.0 and 3GPP TS 37.340 V16.7.0 define the following nodes, amongst others:
gNB: node providing NR user plane and control plane protocol terminations towards the UE, and connected via the NG interface to the 5G core network (5GC).
ng-eNB: node providing E-UTRA user plane and control plane protocol terminations towards the UE, and connected via the NG interface to the 5GC.
En-gNB: node providing NR user plane and control plane protocol terminations towards the UE, and acting as Secondary Node in E-UTRA-NR Dual Connectivity (EN-DC).
NG-RAN node: either a gNB or an ng-eNB.

It will be appreciated that the above embodiments may be applied to 5G New Radio and LTE systems (E-UTRAN), and any future generation systems. A base station that supports E-UTRA/4G protocols may be referred to as an ‘eNB’ and a base station that supports NextGeneration/5G protocols may be referred to as a ‘gNBs’. It will be appreciated that some base stations may be configured to support both 4G and 5G protocols, and/or any other 3GPP or non-3 GPP communication protocols.

In the above description, the UE, the access network node, and the data network node are described for ease of understanding as having a number of discrete modules (such as the communication control modules). Whilst these modules may be provided in this way for certain applications, for example where an existing system has been modified to implement the disclosure, in other applications, for example in systems designed with the inventive features in mind from the outset, these modules may be built into the overall operating system or code and so these modules may not be discernible as discrete entities. These modules may also be implemented in software, hardware, firmware, or a mix of these.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like.

In the above embodiments, a number of software modules were described. As those skilled in the art will appreciate, the software modules may be provided in compiled or un-compiled form and may be supplied to the UE, the access network node, and the data network node as a signal over a computer network, or on a recording medium. Further, the functionality performed by part or all of this software may be performed using one or more dedicated hardware circuits. However, the use of software modules is preferred as it facilitates the updating of the UE, the access network node, and the data network node in order to update their functionalities.

The above embodiments are also applicable to ‘non-mobile’ or generally stationary user equipment.

The method performed by the distributed unit may further comprise transmitting, to the UE, information for configuring a respective multicast radio bearer for receiving the at least one MBS session by the UE in an inactive state. In this case, the transmitting may include transmitting the information for configuring the respective multicast radio bearer using at least one of: a message for releasing a connection of the UE; a system information block; or a multicast control channel.

The information for configuring the respective multicast radio bearer may include configuration for at least one of: a Packet Data Convergence Protocol (PDCP), a Radio Link Control (RLC), a Medium Access Control (MAC), a Multicast Control Channel (MCCH), or a Multicast Traffic Channel (MTCH) associated with the MBS session.

The distributed unit may receive, from the central unit, in the UE context procedure, a message for releasing a UE context associated with the UE, the message including the information identifying the at least one MBS session and identifying that the at least one MBS session is to be provided in the cell via multicast.

The method performed by the distributed unit may further comprise receiving, from the central unit, a further message for releasing the UE to the inactive state. The further message may include the information for configuring a respective multicast radio bearer for the at least one MBS session.

The distributed unit may receive, from the central unit, in the multicast context procedure, a message for setting up or modifying a multicast context associated with the at least one MBS session. The message for setting up or modifying the multicast context may include information identifying whether or not the multicast is mandated to be turned on for the at least one MBS session in the cell.

The method performed by the distributed unit may further comprise transmitting, in the cell via the multicast, data for the at least one MBS session, based on the information identifying the at least one MBS session and identifying that the at least one MBS session is mandated to be provided in the cell via the multicast.

The multicast may include a point-to-multipoint transmission between the distributed unit and a plurality of UEs.

The information received by distributed unit from the associated central unit may include at least one of: information indicating that the UE has reselected to another cell; information identifying the at least one MBS session; or information identifying whether or not multicast is to be turned on for the at least one MBS session in a cell of the distributed unit.

The method performed by the distributed unit may further comprise deactivating the point-to-multipoint transmission associated with the MBS session or switching from the point-to-multipoint transmission associated with the MBS session to a point-to-point transmission, based on the information.

The information received by the network node from the UE may be included in at least one of: a registration request message, a resume request message, a radio access network (RAN) notification area update message, or a small data transmission message. The information may be used in controlling the MBS session in the cell served by the distributed unit.

The network node may be a base station or a core network node responsible for access and mobility of the UE.

The information indicating whether at least one multicast session is provided in a cell may be included in at least one of: a message for releasing a connection of the UE; a system information block associated with the cell; or a multicast control channel associated with the cell. The information may include at least one of: information identifying that the multicast session is mandated to be available in the cell; information identifying at least one Multicast and Broadcast Services (MBS) session that is provided in the cell; information identifying the cell; or information identifying a frequency associated with the cell.

The performing the cell reselection based on the information may include prioritising the cell in a case that the information indicates that the at least one multicast session is provided in the cell.

The information identifying the at least one multicast session may include, for each multicast session, a respective multicast session identifier or a respective temporary mobile group identifier.

Various other modifications will be apparent to those skilled in the art and will not be described in further detail here.

For example, the whole or part of the exemplary embodiments disclosed above can be described as, but not limited to, the following supplementary notes.

### (Supplementary Note 1)

A method performed by a distributed unit of a base station apparatus for providing Multicast and Broadcast Services (MBS) in a cell for a user equipment (UE), the method comprising:
receiving, from a central unit of the base station apparatus, in at least one of a UE context procedure or a multicast context procedure, information identifying at least one MBS session and identifying that the at least one MBS session is to be provided in the cell via multicast.

### (Supplementary Note 2)

The method according to supplementary note 1, further comprising transmitting, to the UE, information for configuring a respective multicast radio bearer for receiving the at least one MBS session by the UE in an inactive state.

### (Supplementary Note 3)

The method according to supplementary note 2, wherein the transmitting includes transmitting the information for configuring the respective multicast radio bearer using at least one of:
a message for releasing a connection of the UE;
a system information block; or
a multicast control channel.

### (Supplementary Note 4)

The method according to supplementary note 2 or 3, wherein the information for configuring the respective multicast radio bearer includes configuration for at least one of:
a Packet Data Convergence Protocol (PDCP),
a Radio Link Control (RLC),
a Medium Access Control (MAC),
a Multicast Control Channel (MCCH), or
a Multicast Traffic Channel (MTCH) associated with the MBS session.

### (Supplementary Note 5)

The method according to any of supplementary notes 1 to 4, wherein the receiving includes receiving, from the central unit, in the UE context procedure, a message for releasing a UE context associated with the UE, the message including the information identifying the at least one MBS session and identifying that the at least one MBS session is to be provided in the cell via multicast.

(Supplementary Note 6) The method according to any of supplementary notes 1 to 5 further comprising receiving, from the central unit, a further message for releasing the UE to the inactive state.

### (Supplementary Note 7)

The method according to supplementary note 6, wherein the further message includes the information for configuring a respective multicast radio bearer for the at least one MBS session.

### (Supplementary Note 8)

The method according to any of supplementary notes 1 to 7, wherein the receiving includes receiving, from the central unit, in the multicast context procedure, a message for setting up or modifying a multicast context associated with the at least one MBS session.

### (Supplementary Note 9)

The method according to supplementary note 8, wherein the message for setting up or modifying the multicast context includes information identifying whether or not the multicast is mandated to be turned on for the at least one MBS session in the cell.

(Supplementary Note 10) The method according to any of supplementary notes 1 to 9, further comprising transmitting, in the cell via the multicast, data for the at least one MBS session, based on the information identifying the at least one MBS session and identifying that the at least one MBS session is mandated to be provided in the cell via the multicast.

### (Supplementary Note 11)

The method according to any of supplementary notes 1 to 10, wherein the multicast includes a point-to-multipoint transmission between the distributed unit and a plurality of UEs.

### (Supplementary Note 12)

A method performed by a central unit of a base station apparatus for providing Multicast and Broadcast Services (MBS) in a cell for a user equipment (UE), the method comprising:
transmitting, to a distributed unit of the base station apparatus, in at least one of a UE context procedure or a multicast context procedure, information identifying at least one MBS session and identifying that the at least one MBS session is to be provided in the cell via multicast.

### (Supplementary Note 13)

A method performed by a distributed unit of a base station apparatus providing a Multicast and Broadcast Services (MBS) session for a user equipment (UE) in an inactive state, the method comprising:
receiving, from an associated central unit, information indicating that a point-to-multipoint transmission associated with the MBS session is no longer mandated.

### (Supplementary Note 14)

The method according to supplementary note 13, wherein the information includes at least one of:
information indicating that the UE has reselected to another cell;
information identifying the at least one MBS session; or
information identifying whether or not multicast is to be turned on for the at least one MBS session in a cell of the distributed unit.

### (Supplementary Note 15)

The method according to supplementary note 13 or 14, further comprising deactivating the point-to-multipoint transmission associated with the MBS session or switching from the point-to-multipoint transmission associated with the MBS session to a point-to-point transmission, based on the information.

### (Supplementary Note 16)

A method performed by a central unit of a base station apparatus providing a Multicast and Broadcast Services (MBS) session for a user equipment (UE) in an inactive state, the method comprising:
transmitting, to a distributed unit of the base station apparatus, information indicating that a point-to-multipoint transmission associated with the MBS session is no longer mandated.

### (Supplementary Note 17)

A method performed by a user equipment (UE), the method comprising:
receiving a Multicast and Broadcast Services (MBS) session in an inactive state, using a point-to-multipoint transmission in a cell served by a distributed unit of a base station apparatus;
performing cell reselection to a new cell; and
transmitting, to a network node associated with the new cell, information indicating that the UE has performed the cell reselection.

### (Supplementary Note 18)

A method performed by a network node, the method comprising:
receiving, from a user equipment (UE), information indicating that the UE has performed a cell reselection to a cell associated with the network node, in a case that a Multicast and Broadcast Services (MBS) session was provided to the UE in an inactive state, prior to the cell reselection, using a point-to-multipoint transmission in a cell served by a distributed unit of a base station apparatus.

### (Supplementary Note 19)

The method according to supplementary note 17 or 18, wherein the information is included in at least one of:
a registration request message,
a resume request message,
a radio access network (RAN) notification area update message, or
a small data transmission message.

### (Supplementary Note 20)

The method according to any of supplementary notes 17 to 19, wherein the information is used in controlling the MBS session in the cell served by the distributed unit.

### (Supplementary Note 21)

The method according to any of supplementary notes 17 to 20, wherein the network node is a base station or a core network node responsible for access and mobility of the UE.

### (Supplementary Note 22)

A method performed by a user equipment (UE), the method comprising:
receiving information indicating whether at least one multicast session is provided in a cell; and
performing a cell reselection based on the information for receiving, in an inactive state, the multicast session.

### (Supplementary Note 23)

The method according to supplementary note 22, wherein the information is included in at least one of:
a message for releasing a connection of the UE;
a system information block associated with the cell; or
a multicast control channel associated with the cell.

### (Supplementary Note 24)

The method according to supplementary note 22 or 23, wherein the information includes at least one of:
information identifying that the multicast session is mandated to be available in the cell;
information identifying at least one Multicast and Broadcast Services (MBS) session that is provided in the cell;
information identifying the cell; or
information identifying a frequency associated with the cell.

### (Supplementary Note 25)

The method according to any of supplementary notes 22 to 24, wherein the performing the cell reselection based on the information includes prioritising the cell in a case that the information indicates that the at least one multicast session is provided in the cell.

### (Supplementary Note 26)

The method according to any of supplementary notes 1, 5, 12, 14, and 24, wherein the information identifying the at least one multicast session includes, for each multicast session, a respective multicast session identifier or a respective temporary mobile group identifier.

### (Supplementary Note 27)

A method performed by a base station, the method comprising:
transmitting information indicating whether at least one multicast session is provided in a cell, for use by a user equipment (UE) in performing a cell reselection for receiving, in an inactive state, the at least one multicast session.

### (Supplementary Note 28)

A distributed unit of a base station apparatus for providing Multicast and Broadcast Services (MBS) in a cell for a user equipment (UE), the distributed unit comprising:
means for receiving, from a central unit of the base station apparatus, in at least one of a UE context procedure or a multicast context procedure, information identifying at least one MBS session and identifying that the at least one MBS session is to be provided in the cell via multicast.

### (Supplementary Note 29)

A central unit of a base station apparatus for providing Multicast and Broadcast Services (MBS) in a cell for a user equipment (UE), the central unit comprising:
means for transmitting, to a distributed unit of the base station apparatus, in at least one of a UE context procedure or a multicast context procedure, information identifying at least one MBS session and identifying that the at least one MBS session is to be provided in the cell via multicast.

### (Supplementary Note 30)

A distributed unit of a base station apparatus providing a Multicast and Broadcast Services (MBS) session for a user equipment (UE) in an inactive state, the distributed unit comprising:
means for receiving, from an associated central unit, information indicating that a point-to-multipoint transmission associated with the MBS session is no longer mandated.

### (Supplementary Note 31)

A central unit of a base station apparatus providing a Multicast and Broadcast Services (MBS) session for a user equipment (UE) in an inactive state, the central unit comprising:
means for transmitting, to a distributed unit of the base station apparatus, information indicating that a point-to-multipoint transmission associated with the MBS session is no longer mandated.

### (Supplementary Note 32)

A user equipment (UE) comprising:
means for receiving a Multicast and Broadcast Services (MBS) session in an inactive state, using a point-to-multipoint transmission in a cell served by a distributed unit of a base station apparatus;
means for performing cell reselection to a new cell; and
means for transmitting, to a network node associated with the new cell, information indicating that the UE has performed the cell reselection.

### (Supplementary Note 33)

A network node comprising:
means for receiving, from a user equipment (UE), information indicating that the UE has performed a cell reselection to a cell associated with the network node, in a case that a Multicast and Broadcast Services (MBS) session was provided to the UE in an inactive state, prior to the cell reselection, using a point-to-multipoint transmission in a cell served by a distributed unit of a base station apparatus.

### (Supplementary Note 34)

A user equipment (UE) comprising:
means for receiving information indicating whether at least one multicast session is provided in a cell; and
means for performing a cell reselection based on the information for receiving, in an inactive state, the multicast session.

### (Supplementary Note 35)

A base station comprising:
means for transmitting information indicating whether at least one multicast session is provided in a cell, for use by a user equipment (UE) in performing a cell reselection for receiving, in an inactive state, the at least one multicast session.

This application is based upon and claims the benefit of priority from Great Britain Patent Application No. 2204294.6, filed on Mar. 25, 2022, the disclosure of which is incorporated herein in its entirety by reference.

### REFERENCE SIGNS LIST

1 TELECOMMUNICATION SYSTEM
3 MOBILE DEVICE
5 BASE STATION
7 CORE NETWORK
9 AMF(s)
10 UPF(s)
11 SMF(s)
31 TRANSCEIVER CIRCUIT
33 ANTENNA
35 USER INTERFACE
37 CONTROLLER
39 MEMORY
41 OPERATING SYSTEM
43 COMMUNICATIONS CONTROL MODULE
45 MBS MODULE
51 TRANSCEIVER CIRCUIT
53 ANTENNA
55 NETWORK INTERFACE
57 CONTROLLER
59 MEMORY
61 OPERATING SYSTEM
63 COMMUNICATIONS CONTROL MODULE
5C gNB-CU-CP MODULE
5U gNB-CU-UP MODULE
5D gNB-DU MOULE
71 TRANSCEIVER CIRCUIT
75 NETWORK INTERFACE
77 CONTROLLER
79 MEMORY
81 OPERATING SYSTEM
83 COMMUNICATIONS CONTROL MODULE
85 MBS MODULE

What is claimed is:

1-30. (canceled)

31. A method performed by a distributed unit of a base station for providing Multicast and Broadcast Services (MBS) in a cell for a user equipment (UE) in a Radio Resource Control (RRC) inactive state, the method comprising:
receiving, from a central unit of the base station, MBS session information indicating whether a transmission mode via multicast to the UE in the RRC inactive state on at least one MBS session is to be activated in the cell or to be deactivated; and
determining to activate the transmission mode via multicast to the UE in the RRC inactive state on the at least one MBS session in the cell or deactivate the transmission mode via multicast to the UE in the RRC inactive state on the at least one MBS session, based on the MBS information.

32. The method according to claim 31, wherein
the MBS session information is included in a Multicast Context Setup Request message or a Multicast Context Modification Request message.

33. The method according to claim 31, wherein
the MBS session information indicates the at least one MBS session.

34. The method according to claim 31, further comprising:
transmitting, to the UE, configuration information for configuring a respective multicast radio bearer for the at least one MBS session.

35. The method according to claim 34, wherein
the configuration information is transmitted using at least one of:
a message for releasing a connection of the UE;
a message for releasing a UE context associated with the UE;
a message for moving the UE to the RRC inactive state;
a message for setting up or modifying a multicast context associated with the at least one MBS session;
a system information block; or
a multicast control channel (MCCH).

36. The method according to claim 34, wherein
the configuration information includes configuration for at least one of:
a Packet Data Convergence Protocol (PDCP);
a Radio Link Control (RLC);
a Medium Access Control (MAC);
a Multicast Control Channel (MCCH); or
a Multicast Traffic Channel (MTCH) associated with the at least one MBS session.

37. The method according to claim 31, further comprising:
transmitting, to the UE, information indicating that the transmission mode via multicast to the UE in the RRC inactive state on at least one MBS session has been activated in the cell.

38. A method performed by a central unit of a base station for providing Multicast and Broadcast Services (MBS) in a cell for a user equipment (UE) in a Radio Resource Control (RRC) inactive state, the method comprising:
transmitting, to a distributed unit of the base station, MBS session information identifying whether a transmission mode for the UE in the RRC inactive state on at least one MBS session is to be activated in the cell via multicast or to be deactivated, wherein
the MBS session information is used by the distributed unit for determining to activate the transmission mode for the UE in the RRC inactive state on the at least one MBS session in the cell via multicast or deactivate the transmission mode for the UE in the RRC inactive state on the at least one MBS session.

39. The method according to claim 38, wherein
the MBS session information is included in a Multicast Context Setup Request message or a Multicast Context Modification Request message.

40. The method according to claim 38, wherein
the MBS session information indicates the at least one MBS session.

41. The method according to claim 38, wherein
the MBS session information is transmitted in a case where the central unit receives at least one of:
a request for a UE context, from another base station; or
information indicating that a UE has reselected another cell, from a core network node for mobility management.

42. A distributed unit of a base station for providing Multicast and Broadcast Services (MBS) in a cell for a user equipment (UE) in a Radio Resource Control (RRC) inactive state, the distributed unit comprising:
at least one memory storing instructions; and
at least one processor configured to process the instructions to:
receive, from a central unit of the base station, MBS session information identifying whether a transmission mode for the UE in the RRC inactive state on at least one MBS session is to be activated in the cell via multicast or to be deactivated; and
determine to activate the transmission mode for the UE in the RRC inactive state on the at least one MBS session in the cell via multicast or deactivate the transmission mode for the UE in the RRC inactive state on the at least one MBS session, based on the MBS session information.

43. A central unit of a base station for providing Multicast and Broadcast Services (MBS) in a cell for a user equipment (UE) in a Radio Resource Control (RRC) inactive state, the central unit comprising:
at least one memory storing instructions; and
at least one processor configured to process the instructions to:
transmit, to a distributed unit of the base station, MBS session information identifying whether a transmission mode for the UE in the RRC inactive state on at least one MBS session is to be provided in the cell via multicast or to be deactivated, wherein
the MBS session information is used by the distributed unit for determining to activate the transmission mode for the UE in the RRC inactive state the at least one MBS session in the cell via multicast or deactivate the transmission mode for the UE in the RRC inactive state on the at least one MBS session.
